(19) United States
(12) Patent Application Publication
(10) Pub. No.: US 2026/0254166 A1
(43) Pub. Date: Aug. 27, 2026

(54) ELECTRICAL CONNECTOR WITH DISCONNECTION ACTUATOR

(71) Applicant: HARTING International Innovation AG, BIEL (CH)

(72) Inventors: Andrew CHANG, Castro Valley, CA (US); Vianney GRENEZ, San Francisco, CA (US); Sarah SOUTHERLAND, Paxton, IL (US); Peter HANNA, Dorval, CA (US)

(21) Appl. No.: 19/162,847

(22) PCT Filed: Feb. 28, 2024
(86) PCT No.: PCT/EP2024/055147

§ 371 Date: Sep. 5, 2025

Related U.S. Application Data
(60) Provisional application No. 63/488,991, filed on Mar. 8, 2023.

(51) Int. Cl. H01R 13/635; H01R 13/639; H01R 103/00

(52) U.S. Cl. CPC H01R 13/635; H01R 13/639; H01R 2103/00

(57) ABSTRACT

A connector includes two parts having contacts, a retainer and a disconnection actuator. The retainer has a latch carried by one part and a retention surface carried by the other part, and the retainer has a latched position and a released position. The disconnection actuator is carried by the first part and engageable with the second part when the first part and second part are engaged to provide a force on the second part to disconnect the second part and the first part. When the retainer is in the latched position the disconnection actuator does not disconnect the second part from the first part, and when the retainer is in the released position the disconnection actuator disconnects the second part from the first part.

This is a provisional patent application under 35 U.S.C. § 111(b).

### TECHNICAL FIELD

The present disclosure relates generally to a connector with a disconnection actuator that may permit automatic disconnection of the connector.

### BACKGROUND

Electrical connectors often include a plug that is partially received in a socket to couple electrical contacts of the plug and socket and provide an electrical connection between the plug and socket. The plug and socket are manually separated to disconnect them. There are applications in which an electrical connector is used that could benefit from automatic disconnection of the connector because, for example, it is difficult or impractical to manually engage with the connector, and so a simple way to automatically disconnect an electrical connector is desired.

### SUMMARY

In at least some implementations, a connector includes a first part having a first contact, a second part having a second contact engageable with the first contact when the first part is connected to the second part, a retainer and a disconnection actuator. The retainer has a latch carried by one of the first part and the second part, and a retention surface carried by the other of the first part and the second part. The retainer has a latched position in which the latch overlaps the retention surface and prevents disconnection of the first part from the second part, and the retainer has a released position in which the latch does not overlap the retention surface. The disconnection actuator is carried by the first part and engageable with the second part when the first part and second part are engaged to provide a force on the second part to disconnect the second part and the first part. When the retainer is in the latched position the disconnection actuator does not disconnect the second part from the first part, and when the retainer is in the released position the disconnection actuator disconnects the second part from the first part.

In at least some implementations, the disconnection actuator includes a plunger and a spring that acts on the plunger to move the plunger to an extended position, and when the first part and second part are connected together, the plunger is moved to a retracted position in which the spring provides a greater force on the plunger than when the plunger is in the extended position. In at least some implementations, the first part includes a bore and the plunger is slidably received in the bore. In at least some implementations, the plunger is slidably carried by the first part for movement between the retracted position and the extended position along a path that is parallel to a direction of movement of connection and disconnection of the first part and second part. In at least some implementations, the first part includes a cavity in which a portion of the second part is received, and an end of the plunger extends into the cavity and is engaged by the second part when the second part is connected to the first part. In at least some implementations, the plunger is arranged parallel to a centerline of at least part of the first contact. In at least some implementations, the disconnection actuator includes a second plunger and a second spring that acts on the second plunger to move the second plunger to an extended position, and when the first part and second part are connected together, the second plunger is moved to a retracted position in which the spring provides a greater force on the second plunger than when the second plunger is in the extended position. A connector may include one, two or more than two plungers that all serve as a disconnection actuator for the connector.

In at least some implementations, the disconnection actuator is electrically actuated to cause disconnection of the second part from the first part. In at least some implementations, the disconnection actuator includes a solenoid having a plunger that is selectively driven to disconnect the second part from the first part.

In at least some implementations, the connector also includes a release actuator coupled to the latch to selectively move the latch to the released position. In at least some implementations, the release actuator is electrically actuated. In at least some implementations, the release actuator includes a solenoid having a plunger that is selectively driven to cause movement of the latch. The release actuator may include any actuator capable of releasing the retainer, such as by moving the latch. The release actuator may be a rotary actuator or a linear actuator which may include a rotary drive (e.g. a gear or screw drive that causes linear motion), pneumatic or other drive mechanism.

In at least some implementations, an electrical connector includes a first part having a first electrical contact, a second part having a second electrical contact engageable with the first electrical contact when the first part is connected to the second part, a retainer, a disconnection actuator and a release actuator. The retainer has a latched position in which the retainer prevents disconnection of the second part from the first part, and the retainer has a released position in which the retainer permits disconnection of the second part from the first part. The disconnection actuator includes a plunger and a spring that acts on the plunger to move the plunger to an extended position. When the first part and second part are connected together, the plunger is moved to a retracted position in which the spring provides a greater force on the plunger than when the plunger is in the extended position. The release actuator is coupled to the retainer to selectively move the retainer to the released position. The release actuator is electrically actuated and upon movement of the retainer to the released position, the spring causes the plunger to move toward its extended position which disconnects the second part from the first part.

In at least some implementations, the plunger is slidably carried by the first part for movement between the retracted position and the extended position along a path that is parallel to a direction of movement of connection and disconnection of the first part and second part.

In at least some implementations, the first part includes a cavity in which a portion of the second part is received, and wherein an end of the plunger extends into the cavity and is engaged by the second part when the second part is connected to the first part. In at least some implementations, the plunger is arranged parallel to a centerline of at least part of the first electrical contact. In at least some implementations, the release actuator includes a solenoid having a plunger that is selectively driven to move the retainer to the released position. Of course, other release actuators may be used, as is noted herein.

### BRIEF DESCRIPTION OF THE DRAWINGS

The following detailed description of preferred implementations and best mode will be set forth with regard to the accompanying drawings, in which:

FIG. 1 is a diagrammatic sectional view of a connector including a first part and a second part shown in a connected state with a retainer in a latched position;

FIG. 2 is a view similar to FIG. 1 showing the retainer in a released position;

FIG. 3 is a view similar to FIG. 1 showing the connector in a disconnected state;

FIG. 4 is a perspective view of an electrical connector including a first part and a second part shown in a connected state, with a retainer in a released position;

FIG. 5 is a perspective view of the first part and second part in a disconnected state, and showing a disconnection actuator carried by the first part;

FIG. 6 is a sectional view of the electrical connector in the connected state;

FIG. 7 is a sectional view of the electrical connector in the disconnected state;

FIG. 8 is a perspective view of one part of an electrical connector including a disconnection actuator;

FIG. 9 is a diagrammatic view of one part of an electrical connector including an electrically activated disconnection actuator; and

FIG. 10 is a diagrammatic sectional view of one part of an electrical connector including an electrically activated disconnection actuator.

### DETAILED DESCRIPTION

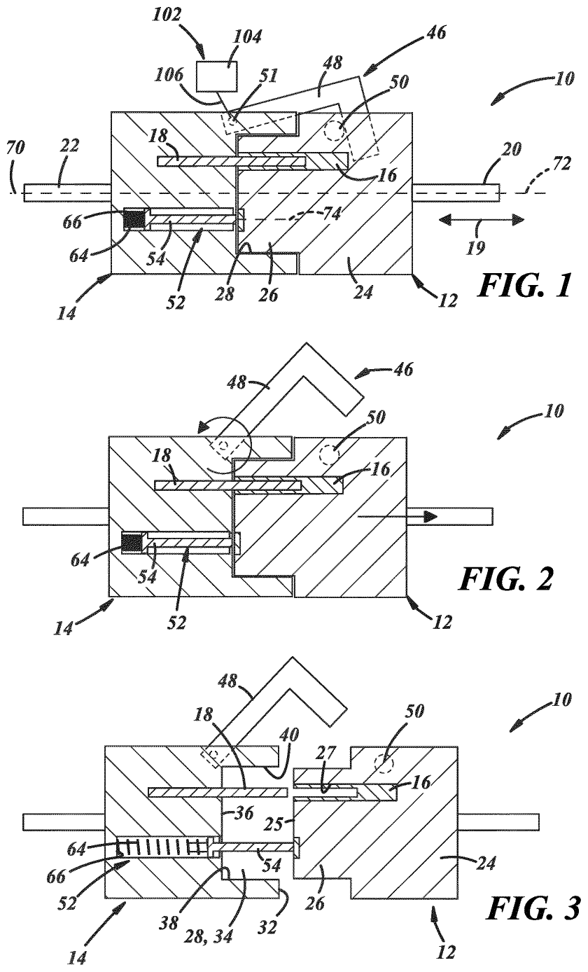

Referring in more detail to the drawings, FIGS. 1-3 illustrate an electrical connector 10 having two halves or parts including a first part 12 and a second part that are releasably coupled together to define an electrical connection between the parts. The parts 12, 14 of the electrical connector 10 may include mating engagement features, which may include male and female structures, like a plug 12 and socket 14, and associated electrical contacts 16, 18 that are electrically coupled together when the two parts 12, 14 are connected together. To facilitate description of the connector 10 parts, the first part 12, which is shown as having a male portion will be called a plug 12, and the second part 14, which is shown as having a female portion will be called a socket 14. An electrical connection may be established between the plug 12 and socket 14 of the electrical connector 10 when the two parts are coupled together, and the connection is terminated when the two parts are disconnected, which occur in a direction of connection/disconnection noted by arrow 19 in FIG. 1. And the plug 12 and socket 14 may be coupled to separate components, like cables 20, 22 or other parts of a circuit (e.g. a circuit board) to electrically connect the components through the connector 10, such as to complete the electrical circuit when the connector 10 is in a connected state, as shown in FIGS. 1 and 3. While shown in these drawings as an electrical connector, the disconnection actuator and related features may be used in other connectors, such as for fiber optic connections and the like. In such contexts, the contacts are elements of the connector through which transmission occurs (e.g. contacting fibers or components through which light is transmitted or passes in a fiber optic connector).

In the example shown in FIGS. 1-3 and 4-7, the plug 12 includes a main body 24 with an insert 26 at one end and defining at least part of a front face 25 (FIGS. 3, 6 and 7) of the body 24, at least a portion of which may be arranged perpendicular to the direction of connection and disconnection of the connector parts 12, 14. The electrical contacts 16 are carried by the plug 12 and provided in any desired number and arrangement, and may extend into the insert 26. In at least some implementations, the plug's electrical contacts 16 are accessible via and may be exposed within one or more openings 27 extending to the front face 25. The contacts 16 may be tubular or otherwise arranged to receive the pin-shaped contacts 18 of the socket, although other arrangements maybe used as desired. Several openings 27 may be provided in the body 24, and each opening may be associated with or open to any desired number of contacts including zero, where an opening in the front face 25 might be provided for a reason other than to permit access to a contact 16. While the periphery of the insert 26 is generally rectangular (e.g. a rectangular prism) in the embodiment shown, the insert 26 may have any desired shape suitable for use with a socket 14 having a corresponding cavity 28. Likewise, the main body 24 may also have a shape different from that shown and a connecting component, like the cable 20, may be arranged differently than that shown, as desired for a particular application.

Further with regard to the example shown in FIGS. 1-7, the socket 14 includes a main body 30 that includes the cavity 28 that is formed in a front face 32 of the socket 14 body 30. The cavity has an interior 34 defined by surfaces of the body 30 that are arranged to receive at least part of the insert 26 of the plug 12. The cavity 28 may have a depth defined between a rear wall 36 and the front face 32 of the socket 14 body, where the cavity is open to/through the front face 32, a width defined between opposed sidewalls 38, 40, and a height or thickness defined between opposed upper and lower walls 42, 44 (FIG. 5). The cavity 28 is shown as being a rectangular prism, open at the front face 32, but may be formed otherwise to cooperate with the insert 26 as desired. Electrical contacts 18 of the socket 14 may be carried by the socket main body 30 in any desired number and arrangement, and may extend into the cavity 28 for plug 12-in coupling with the insert 26 (e.g. via openings 27), in known manner. The socket main body 30 may have a shape different from that shown and a connecting component, like the cable 22, may be arranged differently than that shown, as desired for a particular application.

The electrical connector 10 may include a retainer 46 arranged to selectively retain the connector in the connected state. As shown in FIG. 1, the retainer 46 may have a latched position in which disconnection of the plug 12 and socket 14 is inhibited or prevented. As shown in FIGS. 2-5, the retainer 46 has a released position permitting disconnection of the plug 12 and socket 14. In at least some implementations, the retainer 46 includes a latch 48 carried by one of the plug 12 and socket 14, and a retention surface 50 carried by the other of the plug 12 and socket 14, where the latch 48 is movable so that the latch 48 overlaps the retention surface 50 in the latched position of the retainer 46, and the latch 48 does not overlap the retention surface 50 in the released position of the retainer 46.

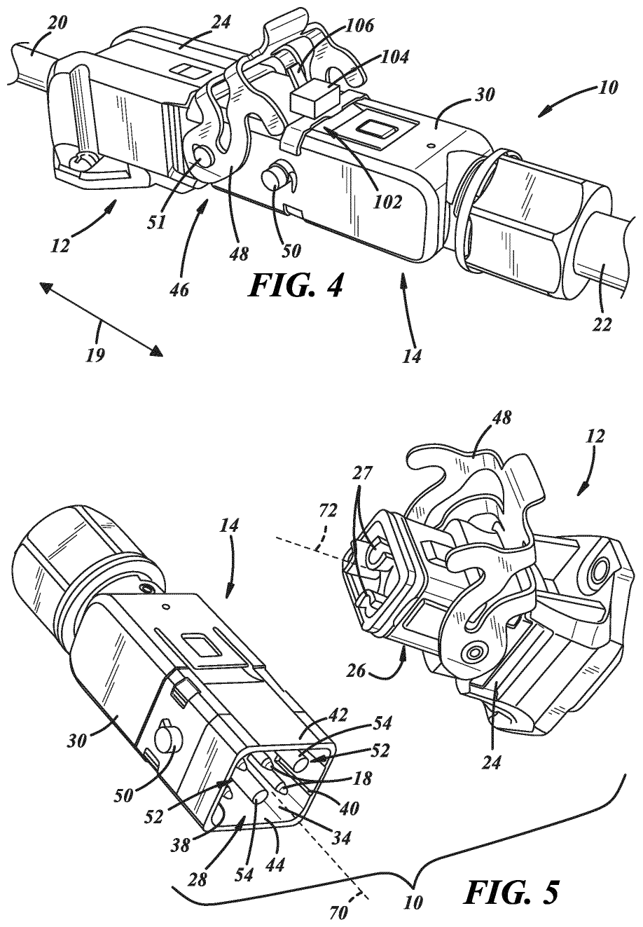

In the example shown in FIGS. 1-3: a) the latch 48 is carried by the socket 14; b) the retention surface 50 is carried by the plug 12; c) the latch 48 is pivoted for rotation about pivot 51; and d) the retention surface 50 is fixed and does not move, and may be defined by an outward projection like a tab or flange on the periphery of the plug main body 24. In the example shown in FIGS. 4 and 5: a) the latch 48 is carried by the plug 12; and b) the retention surface 50 is carried by the socket 14. When the plug 12 and socket 14 are connected together, the retention surface 50 is within a path of movement of the latch 48, and is overlapped by the latch 48 when the latch 48 is advanced toward the retention surface 50, to define the latched position of the retainer 46. In this position, the overlap of the latch 48 and retention surface 50 opposes movement of the connector parts 12, 14 away from each other, and keeps the connector 10 in the connected state, in the connected state. When the latch 48 is rotated away from the retention surface 50, as is shown in FIGS. 2-5, the plug 12 and socket 14 may be separated as desired.

To enable disconnection of the connector 10 without requiring application of manual force to either the plug 12 or socket 14, the connector 10 includes a disconnection actuator 52. The disconnection actuator 52 applies a force to one or both of the plug 12 and socket 14 to separate them.

In at least some implementations, the disconnection actuator 52 includes a plunger 54 carried by one of the plug 12 and socket 14 and arranged to engage and provide a force on the other of the plug 12 and socket 14 when the connector 10 is in the connected stated. In the example shown, for example in FIGS. 4-7, the plunger 54 is carried within a void 56 of the socket body 30 that is open to the cavity 28. The void may include a bore 58 that extends through the rear wall 36 of the socket 14 body, and a counterbore 60 extending from the bore 58 away from the rear wall 36. A free end 62 of the plunger 54 extends into and through the bore 58 and into the cavity 28, and an opposite end of the plunger 54 is received within the counterbore 60 is engaged therein by a spring 64. The spring 64 may be received or extend into the counterbore 60 of the void 56, and may be trapped between a backing surface 66 (e.g. of the main body 30 or of a cap or other component carried by or connected to the main body) and part of the plunger 54. In this regard, the plunger 54 may include a stop surface 68 or flange that may be engaged on one side by the spring 64 by the main body 30 (e.g. at the end of the counterbore 60) to retain the plunger 54 in the main body 30.

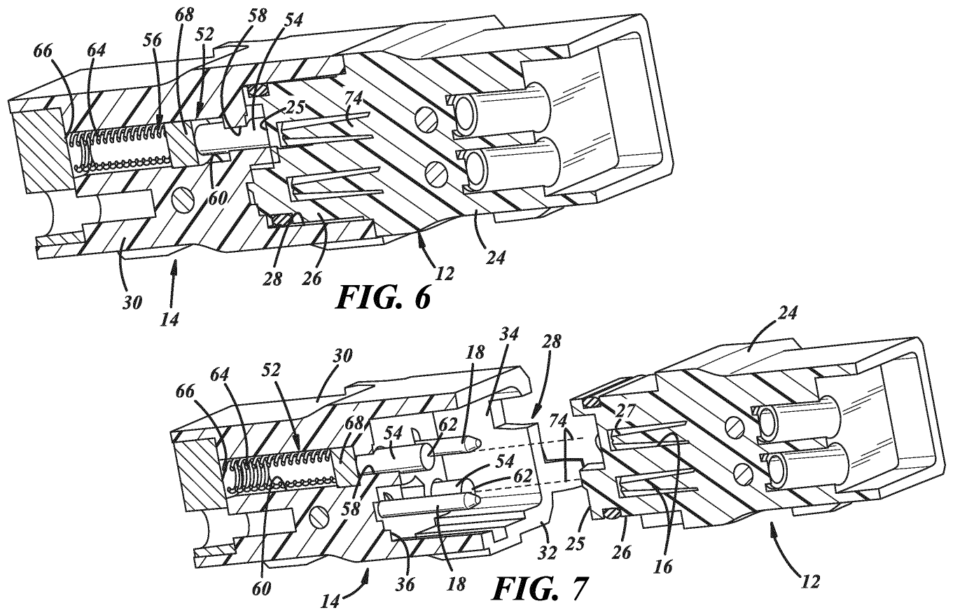

As best shown in FIGS. 5 and 7, more than one plunger 54 may be provided, and the plungers 54 may be spaced apart and arranged as desired. As shown by comparison of FIGS. 2 and 3, as well as by comparison of FIGS. 6 and 7, the plunger 54 is slidably movable within the void 56 between an extended position (FIGS. 3 and 7) and a retracted position (FIGS. 2 and 6). In the extended position, the plunger 54 extends into the cavity 28 through the rear wall 36 a distance sufficient to ensure that the free end 62 of the plunger 54 is engaged by the plug 12 when the plug 12 and socket 14 are moved to the connected state. Thus, during connection of the plug 12 and socket 14, the plug 12 (at the front face 25 or other surface, as desired) engages the free end 62 of the plunger 54 and slidably displaces the plunger 54 in the void 56 and to the retracted position. This movement of the plunger 54 compresses the spring 64 which provides an increased spring force on the plunger 54 tending to move the plunger 54 back to its extended state.

In the retracted position, the plunger 54 provides a force on the plug 12 that is sufficient to separate the plug 12 and socket 14 and automatically move the connector 10 to the disconnected state. The force from the plunger 54 is initially overcome by a force used to move the connector 10 to the connected state, and thereafter, may be overcome by the retainer 46 when in the latched position, in implementations including a retainer 46 (otherwise, a connection force must be maintained to maintain the connector in the connected state). Accordingly, to disconnect the connector 10 the connection force is reduced or terminated, or the retainer 46 is moved to its released position, which allows the spring 64 to displace the plunger 54 toward its extended position and cause the plunger 54 to move the plug insert 26 out of the socket cavity 28.

In at least some implementations, the plungers 54 are parallel to and spaced from the electrical contacts 16, 18, at least a portion of the electrical contacts that are within the cavity 28, which may be arranged in the direction of connection and disconnection of the connector 10 (e.g. the direction 19 in which the insert 26 is received in the cavity 28). And the direction of connection and disconnection (denoted by arrow 19) may, as shown in FIG. 1, be parallel to a centerline 70 of the cavity 28 and/or a centerline 72 of the front face 25 of the plug insert 26. In this way, in at least some implementations, a centerline 74 of the plungers 54 may be arranged parallel to the centerline of the plug insert 26 and/or cavity, or parallel to the electrical contacts 16, 18, or parallel to openings 27 in the plug insert 26 or parallel to the direction of insertion/removal of the plug 12 into and out of the socket 14.

In examples using multiple plungers 54, the plungers 54 may be uniformly spaced relative to the desired centerline 70 or 72 of the cavity 28 or plug insert 26, to likewise provide a combined force from the plungers 54 that moves the insert straight out of the cavity 28 and facilitate reliable disconnection of the plug 12 and socket 14. In implementations having a socket 14 with a rectangular cavity, the plungers 54 may be arranged on lines from the center of the cavity to a corner of the cavity, and/or from the center of the cavity to a midpoint of a side of the rectangle, with multiple plungers 54 being arranged to provide a uniform, balanced force in the direction of disconnection (e.g. with pairs of actuators being equidistant from the center, and 180 degrees apart). The plungers 54 may be arranged between adjacent electrical contacts and/or between the contacts and a wall defining the cavity 28 (for plungers 54 in socket 14), or otherwise as desired. In at least some implementations, the connector part including the plunger 54 has space between electrical contacts and the plunger may be received in the space normally reserved or including such contacts. In this way, the plunger(s) may be easily added to a connector configuration without having to change the main body of a connector part, and without loss of a needed number of electrical contacts, in at least some applications.

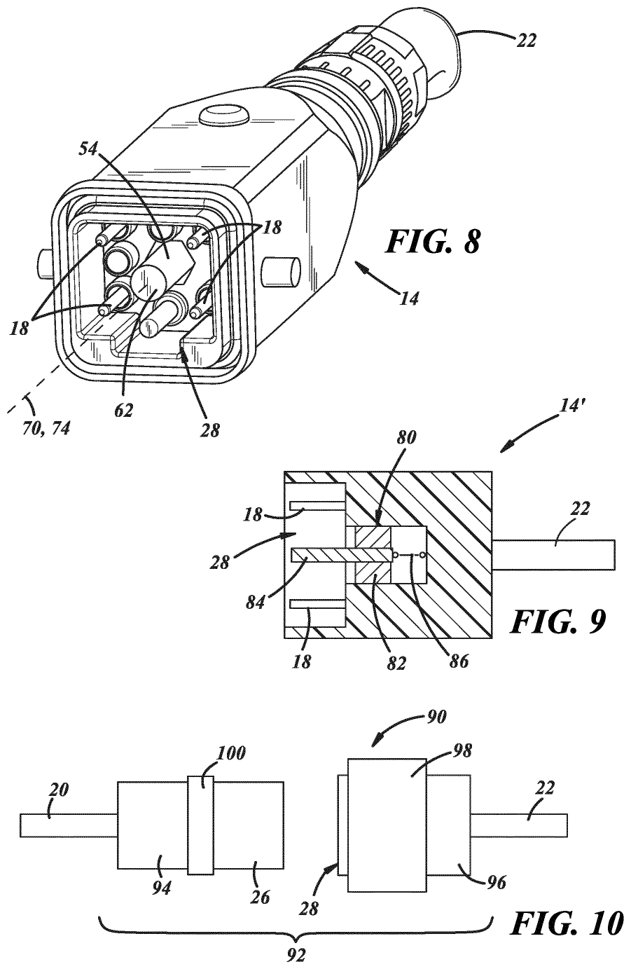

With a single plunger 54, as shown in FIG. 8, the plunger 54 may be centered within the cavity 28. That is, the centerline 74 of the plunger 54 may overlap or be coincident with the centerline 70 of the cavity 28, so that the disconnection force provided by the plunger 54 is applied to the center of an insert 26 to limit tilting of the plug 12 as it is pushed out of the socket 14 (or the socket is pushed away from the plug) and thereby inhibit jamming of the connector 10 and to facilitate smooth disconnection of the connector.

Further, the plungers 54 may be shaped as desired. In the example shown, the plungers 54 are cylindrical rods and have a planar free end 62. The free end 62 may be arranged perpendicular to the center axis 74 of the plunger 54 and arranged to distribute the disconnection force over a desired surface area. The planar, perpendicular free end 62 also facilitates application of the disconnection force in the direction of connection/disconnection to inhibit tilting of the plug 12 and jamming of the connector 10 during the disconnection movement.

In the example shown in FIGS. 1-8, the disconnection actuators 52 (e.g. the plungers 54 and springs 64) provide a force tending to disconnect the connector 10 whenever the connector is in the connected state. When disconnection is not desired, the disconnection force of the actuators 52 is resisted to prevent separation of the plug 12 and socket 14 when the retainer 46 is in the latched position. Upon movement of the retainer 46 to the released position, the disconnection force from the actuators 52 separates the plug 12 and socket 14 automatically.

While the plungers 54 are shown as being carried by the socket 14, they could instead be carried by the plug 12 and arranged to push on a surface of the socket 14 (e.g. the rear wall 36), or plungers 54 may be carried by both the socket 14 and plug 12. Further, instead of always applying a disconnection force when the connector is connected, a disconnection actuator could be electrically controlled and actuated only when desired to cause a disconnection.

Another connector part, shown as a socket 78, has an electrically controlled disconnection actuator 80 as shown in FIG. 9. This disconnection actuator 80 may be or include a solenoid having a wire coil 82 and an armature or plunger 84. When electricity is applied to the coil 82, a magnetic field is generated, and the plunger 84 is displaced by the magnetic field. In this way, the plunger 84 may be displaced when desired, by application or termination of electricity to the coil 82, and the plunger 84 may engage the opposite connector part to disconnect the connector parts. The solenoid actuating signal (e.g. power supply) may be provided via the cable 22 of the associated connector part. In the example shown, the plunger 84 is biased by a spring 86, which is optional, and the plunger 84 is engaged and displaced against the spring 86 when the connector is in the connected state, so the spring 86 may provide a force assisting movement of the plunger 84 during its movement to disconnect the connector parts. The socket 78 may otherwise be constructed and arranged as set forth with regard to socket 14 and similar reference numbers are used to denote the contacts 18 and cavity 28 for ease of reference.

Another example of an electrically controlled disconnection actuator 90 is shown in FIG. 10 with respect to an electrical connector 92 having a plug 94 and a socket 96. This connector includes a wire coil 98 carried by or associated with one part, shown as the socket 96, with the plug 94, having or including a magnet or magnetically responsive body 100, where magnetically responsive means that the body experiences and tends to be displaced by a force of a magnetic field. When electricity is applied to the coil 98, a magnetic field is generated. When the plug 94 is connected to the socket 96, the magnetic body 100 is closer to the coil 98, and the magnetic body 100 and coil 98 are constructed so that the magnetic body 100 is repelled by the magnetic field generated by the coil 98 when the coil is energized. In this way, to disconnect the plug 94 from the socket 96, the coil 98 is energized and the resulting magnetic field drives the magnetic body 100 away from the coil 98. The plug 94 and socket 96 may otherwise be constructed and arranged as set forth with regard to plug 12 and socket 14 and similar reference numbers are used to denote the plug insert 26 and cavity 28 of the socket for ease of reference.

While the implementations of FIGS. 9 and 10 show electromagnetic disconnection actuators, other types of electrically controlled actuators may be used. For example, the actuator could include a motor or other device to cause linear or rotary movement suitable to cause disconnection, such as a screw that is rotated to move linearly, a pneumatically driven plunger, a rotated cam, or other mechanisms.

In at least some implementations, such as is shown in FIG. 1, the retainer 46 is moved to the released position by an electrically controlled release actuator 102. The release actuator 102 could be a solenoid 104 with a plunger 106 that moves in response to application of electricity to the solenoid (or termination of electricity to the solenoid), where the plunger 106 movement causes the retainer 46 to move to the released position. In this way, both the release of the retainer 46 and the disconnection of the connector 10 can be implemented without manual action on the connector 10. The release actuator may include any actuator capable of releasing the retainer, such as by moving the latch. For example, the release actuator may be a rotary actuator that directly rotates the latch, or a linear actuator, or a linear actuator that may include a rotary drive (e.g. a gear or screw drive that causes linear motion), pneumatic or other drive mechanism. Upon electrical activation, the release actuator moves the retainer to the released position.

In at least some implementations, to ensure complete disconnection of the connector parts, the force applied by one or more disconnection actuators 52, 80, 90 is at least equal to, and may be between 50% and 300% greater, or more, than the nominal disconnection force for the connector. In this context, the nominal disconnection force is an average force needed to disconnect connector parts measured by a simple pull test providing a magnitude of the force needed to separate the parts. It is noted that, in the examples in which compressed springs provide a disconnection force, the compressed springs provide a higher force when compressed more, which corresponds to the fully connected position of the connector. The higher spring force in this position works well because a higher disconnection force is needed in the fully connected position, as the surface area of overlap is greatest in this position and static friction must be overcome to cause movement between the connector parts. During the disconnection movement, a lower, sliding friction force acts on less overlapped surface area of the connector parts, so lower disconnection force is needed to continue movement to the fully disconnected position. This lower disconnection force requirement works well with the lower force output from the springs as they decompress during the plunger's advancing stroke during disconnection. Thus, the general force requirements match well with the general trend of force output from springs, and the disconnection force output can be maintained at all times equal to or greater than the required disconnection force.

Automatic disconnection of the connector, without manual/human force, may be helpful in many applications wherein manual interaction is not possible or is difficult. For example, with a drone or other controllable apparatus or vehicle may be powered by a cable 20 or 22, or be connected to a cable to provide signals (e.g. from sensors) via the cable, and disconnection of the drone from a cable while the drone is remote from the operator (e.g. in the air for a flying drone, or in the water for a submersible drone) may be desired in certain circumstances. To do so, the release actuator 96 (or electrically controlled disconnection actuator 80, 90) may be commanded to cause disconnection of the connector. This would enable the drone to move without power supply cable. Other examples include connectors that are difficult for a person to reach (behind large equipment, or a wall, or the like). Still other examples exist, such as where automatic disconnection is desired for other reasons, for example, upon a condition outside of a threshold being sensed (e.g. temperature, current draw, etc). In such an application, when the condition outside the threshold is sensed the release actuator 96 or electrically actuated disconnection actuator 80, 90 can be automatically activated by a controller responsive to the sensed condition (e.g. communicated with a sensor for the condition) to enable automatic disconnection of the connection without requiring a human to send the signal to initiate the disconnection.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

All terms used in the claims are intended to be given their broadest reasonable construction and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A connector, comprising:
a first part having a first contact;
a second part having a second contact engageable with the first contact when the first part is connected to the second part;
a retainer having a latch carried by one of the first part and the second part and a retention surface carried by the other of the first part and the second part, the retainer has a latched position in which the latch overlaps the retention surface and prevents disconnection of the first part from the second part, and the retainer has a released position in which the latch does not overlap the retention surface; and
a disconnection actuator carried by the first part and engageable with the second part when the first part and second part are engaged to provide a force on the second part to disconnect the second part and the first part, and wherein, when the retainer is in the latched position the disconnection actuator does not disconnect the second part from the first part and when the retainer is in the released position the disconnection actuator disconnects the second part from the first part.

2. The connector of claim 1 wherein the disconnection actuator includes a plunger and a spring that acts on the plunger to move the plunger to an extended position, and when the first part and second part are connected together, the plunger is moved to a retracted position in which the spring provides a greater force on the plunger than when the plunger is in the extended position.

3. The connector of claim 2 wherein the first part includes a bore and the plunger is slidably received in the bore.

4. The connector of claim 2 wherein the plunger is slidably carried by the first part for movement between the retracted position and the extended position along a path that is parallel to a direction of movement of connection and disconnection of the first part and second part.

5. The connector of claim 2 wherein the first part includes a cavity in which a portion of the second part is received, and wherein an end of the plunger extends into the cavity and is engaged by the second part when the second part is connected to the first part.

6. The connector of claim 2 wherein the plunger is arranged parallel to a centerline of at least part of the first contact.

7. The connector of claim 2 which also include a second plunger and a second spring that acts on the second plunger to move the second plunger to an extended position, and when the first part and second part are connected together, the second plunger is moved to a retracted position in which the spring provides a greater force on the second plunger than when the second plunger is in the extended position.

8. The connector of claim 1 wherein the disconnection actuator is electrically actuated to cause disconnection of the second part from the first part.

9. The connector of claim 8 wherein the disconnection actuator includes a solenoid having a plunger that is selectively driven to disconnect the second part from the first part.

10. The connector of claim 1 which also includes a release actuator coupled to the latch to selectively move the latch to the released position.

11. The connector of claim 10 wherein the release actuator is electrically actuated.

12. The connector of claim 11 wherein the release actuator includes a solenoid having a plunger that is selectively driven to cause movement of the latch.

13. A connector, comprising:
a first part having a first contact;
a second part having a second contact engageable with the first contact when the first part is connected to the second part;
a retainer having a latched position in which the retainer prevents disconnection of the second part from the first part, and the retainer has a released position in which the retainer permits disconnection of the second part from the first part;
a plunger and a spring that acts on the plunger to move the plunger to an extended position, wherein when the first part and second part are connected together, the plunger is moved to a retracted position in which the spring provides a greater force on the plunger than when the plunger is in the extended position; and
a release actuator coupled to the retainer to selectively move the retainer to the released position, wherein the release actuator is electrically actuated and upon movement of the retainer to the released position, the spring causes the plunger to move toward its extended position which disconnects the second part from the first part.

14. The connector of claim 13 wherein the plunger is slidably carried by the first part for movement between the retracted position and the extended position along a path that is parallel to a direction of movement of connection and disconnection of the first part and second part.

15. The connector of claim 13 wherein the first part includes a cavity in which a portion of the second part is received, and wherein an end of the plunger extends into the cavity and is engaged by the second part when the second part is connected to the first part.

16. The connector of claim 13 wherein the plunger is arranged parallel to a centerline of at least part of the first contact.

17. The connector of claim 13 wherein the release actuator includes a solenoid having a plunger that is selectively driven to move the retainer to the released position.
